(19) United States
(12) Patent Application Publication
(10) Pub. No.: US 2023/0013557 A1
(43) Pub. Date: Jan. 19, 2023

(54) VISUAL ASSETS OF AUDIOVISUAL SIGNALS

(71) Applicant: HEWLETT-PACKARD DEVELOPMENT COMPANY, L.P., Spring, TX (US)

(72) Inventors: Rafael DAL ZOTTO, Porto Alegre (BR); Michael JENNEY, Spring, TX (US)

(21) Appl. No.: 17/378,534

(22) Filed: Jul. 16, 2021

(51) Int. Cl. G06F 40/30; G06F 3/0484

(52) U.S. Cl. CPC G06F 40/30; G06F 3/0484

(57) ABSTRACT

In some examples, an electronic device includes a network interface and a processor. The processor is to analyze an audiovisual signal received via the network interface to identify a topic, identify information related to the topic, and cause a display device to display a visual asset for the information in a video representing the audiovisual signal.

### BACKGROUND

Electronic devices such as notebooks, laptops, desktops, tablets, and smartphones may include executable code that enables users to attend virtual meetings (e.g., a videoconferencing application). A virtual meeting, as used herein, may be any online event that allows a user of an electronic device to interact with users of other electronic devices by transmitting and receiving audiovisual signals. Virtual meetings provide the user with opportunities to work with colleagues, attend educational seminars, and meet with family members, friends, and other users having shared interests, or a combination thereof.

### BRIEF DESCRIPTION OF THE DRAWINGS

Various examples are described below referring to the following figures.

FIG. 1 is a block diagram depicting a system for displaying visual assets of audiovisual signals, in accordance with various examples.

FIG. 2 is a flow diagram depicting a method for an electronic device to display visual assets of audiovisual signals, in accordance with various examples.

FIG. 3 is a block diagram depicting a system for displaying visual assets of audiovisual signals, in accordance with various examples.

FIG. 4 is a block diagram depicting a system for displaying visual assets of audiovisual signals, in accordance with various examples.

FIG. 5 is a block diagram depicting an electronic device for displaying visual assets of audiovisual signals, in accordance with various examples.

FIG. 6 is a flow diagram depicting a method for an electronic device to display visual assets of audiovisual signals, in accordance with various examples.

### DETAILED DESCRIPTION

As described above, electronic devices include executable code that enables users to attend virtual meetings to interact with and expand their personal networks and increase their personal knowledge. Multiple topics may be discussed during a virtual meeting. Additionally, a user may receive a task (e.g., an action item, a to-do list) as a result of attending the virtual meeting. Keeping track of the multiple topics, searching for relevant information, or attempting to perform the task may distract the user from staying present during the virtual meeting and reduce user productivity.

To mitigate the distractions and provide real-time assistance to the user, this description describes an electronic device that displays visual assets of audiovisual signals within virtual meetings. A visual asset, as used herein, is data inserted into a video of an audiovisual signal. The visual asset may be an image, a video, text, or a combination thereof. The electronic device creates a real-time transcript of audio data of the audiovisual signals of a virtual meeting. The real-time transcript, as used herein, is a text that is generated concurrently with the ongoing virtual meeting. Analyzing the real-time transcript, the electronic device continually identifies topics as the virtual meeting progresses. The electronic device identifies information related to a topic via a knowledge pool. The knowledge pool may be customized to an individual user, a group of individuals having shared interests, an organization, a business entity, or an industry, for example. The electronic device inserts the visual asset representing the information into the video of the audiovisual signal. The visual asset may be an image for executable code (e.g., graphical user interface (GUI) for an application), an image that is a link to a website, an instructional video, or text that is a link to a website, for example. The user may interact with the visual asset to access the information or to perform a task, for example. In some examples, the visual asset may notify the user of performance issues with the electronic device (e.g., poor network connectivity, excessive memory usage, excessive central processing unit (CPU) usage, excessive temperatures, low battery, or a combination thereof). In various examples, the electronic device transmits the visual asset to other attendees of the virtual meeting.

Utilizing the electronic device to identify topics of a virtual meeting and identify information related to the topics to present in the user’s video stream as visual assets enhances the productivity of the user. Providing early notification to the user of performance issues of the electronic device enhances the user experience by allowing the user to take corrective action. Transmitting the early notification of performance issues of the user to other attendees of the virtual meeting, enhances the attendee experience by alerting the attendees to a potential impact on the virtual meeting and enhances the productivity of the attendees by allowing them to proactively adapt to the impact. For example, the attendees may rearrange an agenda of the virtual meeting to accommodate the performance issues of the user. Providing the information related to the topics to both the user and the attendees enhances productivity during the virtual meeting by facilitating the sharing of and access to relevant information.

In some examples in accordance with the present description, an electronic device is provided. The electronic device includes a network interface and a processor. The processor is to analyze an audiovisual signal received via the network interface to identify a topic, identify information related to the topic, and cause a display device to display a visual asset for the information in a video representing the audiovisual signal.

In other examples in accordance with the present description, an electronic device is provided. The electronic device includes a network interface and a processor. The processor is to analyze audio data of an audiovisual signal received via the network interface to identify a first topic, analyze a performance of the electronic device to identify a second topic, identify information related to the first and the second topics, and cause a display device to display a video representing the audiovisual signal, the video including a graphical user interface (GUI) to access the information related to the first topic and text for the information related to the second topic.

In various examples in accordance with the present description, a non-transitory machine-readable medium storing machine-readable instructions is provided. Non-transitory includes all electronic mediums or media of storage, except signals. The non-transitory machine-readable medium stores machine-readable instructions, which, when executed by a processor of an electronic device, cause the processor to create a real-time transcript of audio data of a first audiovisual signal received via a network interface and audio data of a second audiovisual signal received via an audio input device, identify a topic of the real-time transcript utilizing a machine learning technique, identify information related to the topic via the network interface, insert a visual asset for the information in a first video representing the first audiovisual signal and in a second video representing the second audiovisual signal, cause a display device to display the first video comprising the visual asset, and cause the network interface to transmit the second audiovisual signal comprising the visual asset.

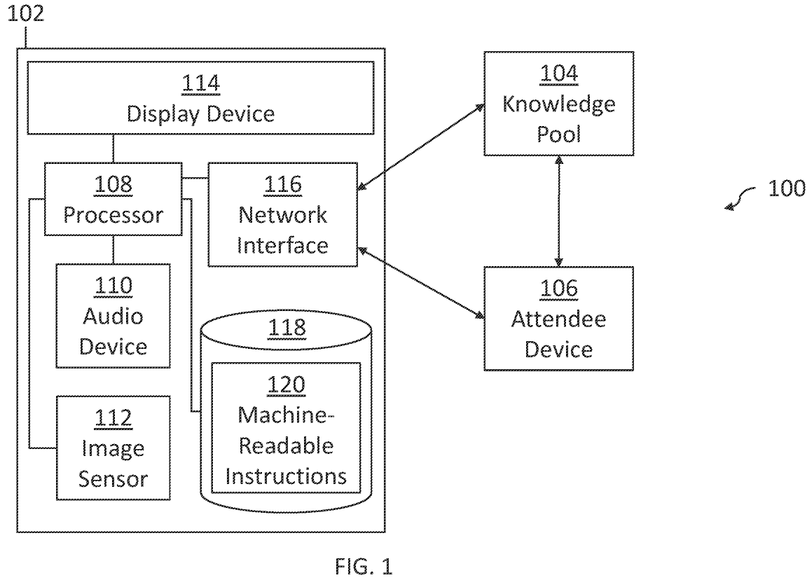

Referring now to FIG. 1, a block diagram depicting a system 100 for displaying visual assets of audiovisual signals is provided, in accordance with various examples. The system 100 may include an electronic device 102, a knowledge pool 104, and an attendee device 106. The electronic device 102 may be a desktop, a laptop, a notebook, a tablet, a smartphone, or any other suitable computing device that includes executable code that enables a processor of the computing device to communicate with the knowledge pool 104, the attendee device 106, or a combination thereof. The knowledge pool 104 may be a processing environment that includes an electronic device (e.g., server, central server, edge server, or some other suitable computing device for sharing processing and memory resources) or a network of electronic devices (e.g., local area network (LAN), wide area network (WAN), virtual private network (VPN), client/server network, Internet (e.g., cloud), or any other suitable system for sharing processing and memory resources). The attendee device 106 may be a desktop, a laptop, a notebook, a tablet, a smartphone, or any other suitable computing device that includes executable code that enables a processor of the computing device to communicate with the electronic device 102, the knowledge pool 104, or a combination thereof.

The electronic device 102 comprises a processor 108, an audio device 110, an image sensor 112, a display device 114, a network interface 116, and a storage device 118. The processor 108 may be a microprocessor, a microcomputer, a microcontroller, a programmable integrated circuit, a programmable gate array, or other suitable device for managing operations of the electronic device 102. The audio device 110 may be an audio input device, an audio output device, or a combination thereof. The audio input device may be an internal microphone, an external microphone, a headset, or any other suitable sound recording device. The audio output device may be an internal speaker, an external speaker, a headset, or any other suitable playback device. The image sensor 112 may be an internal camera, an external camera, or any other suitable video recording device. The display device 114 may be a liquid crystal display (LCD), a light-emitting diode (LED) display, a plasma display, a quantum dot (QD) LED display, or any suitable device for displaying data of the electronic device 102 for viewing. The network interface 116 may be any suitable device for facilitating communications between the electronic device 102 and the knowledge pool 104, the attendee device 106, or a combination thereof. The storage device 118 may be a hard drive, a solid-state drive (SSD), flash memory, random access memory (RAM), or other suitable memory device for storing data and executable code of the electronic device 102. The storage device 118 may store machine-readable instructions, which, when executed by the processor 108, cause the processor 108 to perform some or all of the actions attributed herein to the electronic device 102. The machine-readable instructions may be the machine-readable instructions 120. While not explicitly shown, the electronic device 102 may also include a video adapter, a sound card, local buses, input/output devices (e.g., a mouse, a keyboard, a touchpad), or a combination thereof.

While not explicitly shown, the knowledge pool 104 may include a network interface, a processor, and a storage device. The network interface may enable communication over a network. The network interface may include a wired connection, such as Ethernet or universal serial bus (USB), or a wireless connection, such as WI-FIⓇ or BLUETOOTH®. The processor may be a microprocessor, a microcomputer, a microcontroller, or other suitable controller for managing operations of the knowledge pool 104. The storage device may be a hard drive, solid state drive (SSD), flash memory, random access memory (RAM), or other suitable memory. In some examples, such as when the storage device is a remotely managed storage device (e.g., enterprise cloud, public cloud, data center, server, or some other suitable storage device), the processor may be communicatively coupled to the storage device via a path coupling the network interface and the storage device. In other examples, such as when the processor and the storage device are located on a same electronic device, the storage device may couple to the processor. The storage device may store machine-readable instructions, which, when executed by the processor, cause the processor to perform some or all of the actions attributed herein to the knowledge pool 104.

While not explicitly shown, the attendee device 106 may include a processor, a storage device, an audio device connector, an image sensor connector, a network interface, a video adapter, a sound card, local buses, input/output devices, a display device, or a combination thereof. In various examples, the attendee device 106 may also be the electronic device 102.

In some examples, the electronic device 102 couples to the knowledge pool 104 and the attendee device 106. The knowledge pool 104 couples to the electronic device 102 and the attendee device 106. The attendee device 106 couples to the electronic device 102 and the knowledge pool 104. The electronic device 102, the knowledge pool 104, and the attendee device 106 may couple via a wired connection (e.g., Ethernet, USB), a wireless connection (e.g., a wireless transceiver that enables WI-FIⓇ, BLUETOOTH®), or a combination thereof. In some examples, a network server (not explicitly shown) may facilitate data transfers between the electronic device 102, the knowledge pool 104, and the attendee device 106.

In some examples, the processor 108 couples to the audio device 110, the image sensor 112, the display device 114, the network interface 116, and the storage device 118. While the audio device 110 is shown as an internal audio device 110, in other examples, the audio device 110 may couple to the processor 108 via a wired connection (e.g., audio jack, USB) or wireless connection (e.g., BLUETOOTH®, WI-FI®). While the image sensor 112 is shown as an internal image sensor 112, in other examples, the image sensor 112 may couple to the processor 108 via a wired connection (e.g., USB) or a wireless connection (e.g., BLUETOOTH®, WI-FI®). While the display device 114 is shown as an integrated display device 114 of the electronic device 102, in other examples, the display device 114 may be coupled to the electronic device 102 via a wired connection (e.g., USB, Video Graphics Array (VGA), Digital Visual Interface (DVI), High-Definition Multimedia Interface (HDMI)) or a wireless connection (e.g., WI-FI®, BLUETOOTH®). In some examples, the display device 114 may be a flexible display. Flexible display, as used herein, is a display device 114 that may be deformed (e.g., rolled, folded, etc.) within a given parameter or specification (e.g., a minimum radius of curvature) without losing electrical function or connectivity. The network interface 116 may couple to the knowledge pool 104, the attendee device 106, or a combination thereof via a wired connection (e.g., Ethernet), a wireless connection (e.g., BLUETOOTH®, WI-FI®), or a combination thereof.

As described above, the electronic device 102 displays visual assets of audiovisual signals within a virtual meeting to mitigate distractions and provide real-time assistance to a user. The processor 108 creates a real-time transcript of the virtual meeting. Analyzing the real-time transcript, the processor 108 identifies topics. The processor 108 identifies information related to a topic via the knowledge pool 104. The processor 108 inserts a visual asset representing the information into a video of an audiovisual signal. The processor 108 causes the display device 114 to display the video.

In various examples, the processor 108 creates the real-time transcript utilizing a statistical technique such as a Hidden Markov Model (HMM) or a Guassian Mixture Model (GMM) to extract features from an audio data, analyze the features utilizing statistical analysis, and determine a text sequence based on the analysis. In some examples, the processor 108 utilizes speaker diarization to indicate whether a user or other attendee is speaking. In some examples, the processor 108 may insert a time stamp into the real-time transcript when a speaker changes.

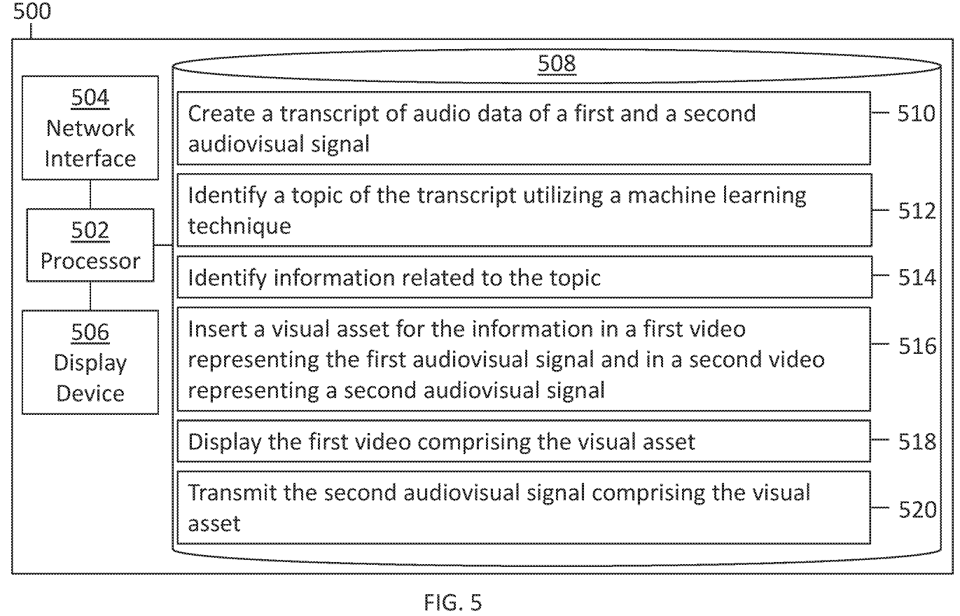

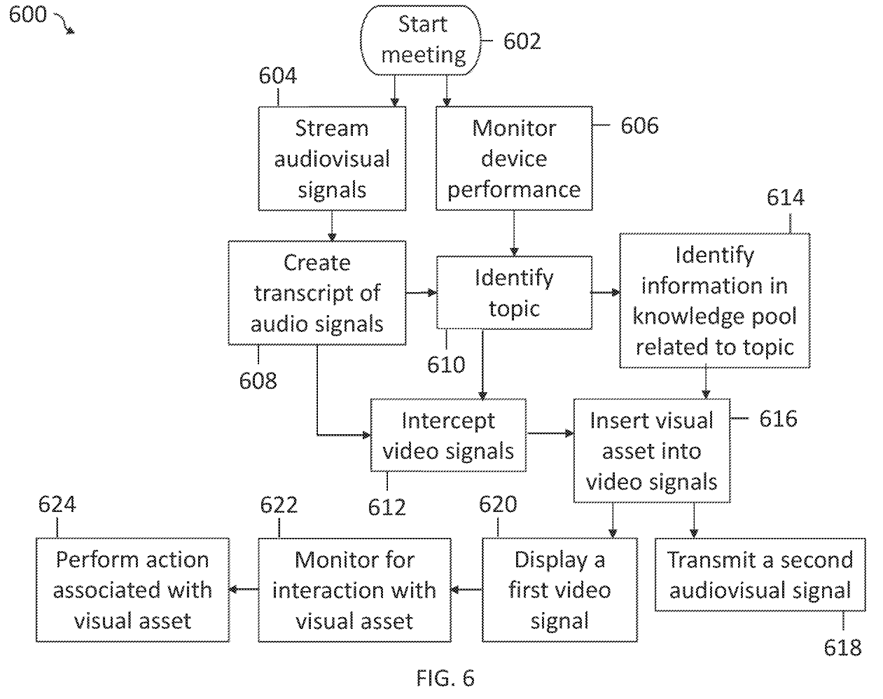

In some examples, the processor 108 utilizes a machine-learning technique as described below with respect to FIGS. 5 and 6, a statistical technique such as HMM or GMM, or a combination thereof to analyze the real-time transcript and identify topics. The processor 108 may use the statistical technique to identify topics by searching the real-time transcript for repeated words, repeated phrases, entity identifiers, or a combination thereof. In various examples, the processor 108 identifies information related to the topics by transmitting a topic to the knowledge pool 104. The knowledge pool 104 transmits information related to the topic to the processor 108. The information may include a visual asset, a command, an action, a specified duration, a location, other data associated with the visual asset, or a combination thereof. The processor 108 may identify the visual asset associated with the information when decrypting the information received from the knowledge pool 104. For example, the processor 108 may identify the visual asset as a graphical user interface (GUI) for an application (e.g., a word processing application, a spreadsheet application, a presentation application, a video streaming application, an audio streaming application), a link to a file comprising data associated with the application, or a combination thereof. In another example, the processor 108 may identify the visual asset as a link to a website, a link to the data associated with the website, or a combination thereof.

In various examples, the knowledge pool 104 may be customized to an individual user, a group of individuals having shared interests, an organization, a business entity, or an industry. For example, the knowledge pool 104 may include information about websites the individual user visits on a periodic basis, topics the individual user researches via the Internet, applications that the individual user executes on a periodic basis, or a combination thereof.

In various examples, the knowledge pool 104 may utilize information associated with a domain. Domain, as used herein, is a network of electronic devices. The network may be for the individual user, the group of individuals having shared interests, the organization, the business entity, or the industry. The processor 108 may determine the domain by examining an Internet Protocol (IP) address of the electronic device 102, the knowledge pool 104, the attendee device 106, or a combination thereof. For example, the knowledge pool 104 may include information about the business entity, websites associated with the business entity, or applications utilized by the business entity. In another example, the knowledge pool 104 may include information about websites the group of individuals having shared interests visits on a periodic basis, topics the group of individuals researches via the Internet, applications that the group of individuals executes on a periodic basis, or a combination thereof.

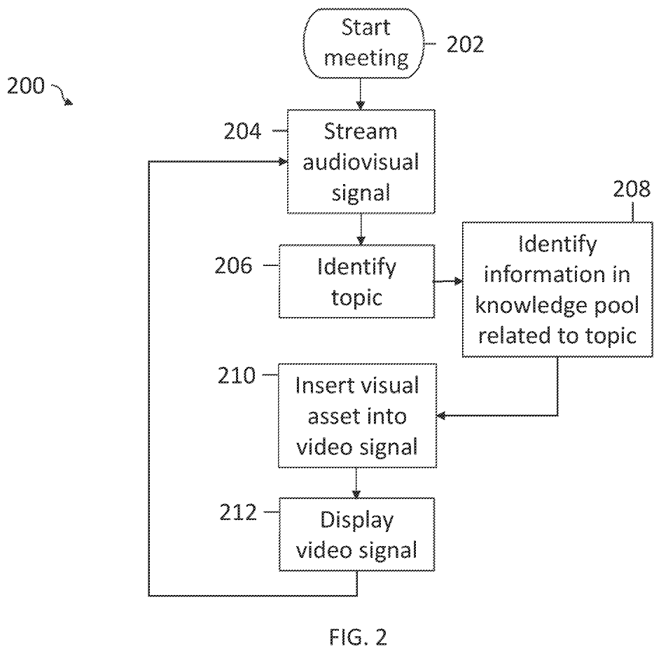

Referring now to FIG. 2, a flow diagram depicting a method 200 for the electronic device 102 to display visual assets of audiovisual signals is provided, in accordance with various examples. At a start point 202 of the method 200, the processor 108 executes an executable code that enables a virtual meeting. The processor 108 causes the display device 114 to display a video of an audiovisual signal, cause an audio output device (e.g., the audio device 110) to play an audio data of the audiovisual signal, or a combination thereof during a streaming process 204 of the method 200. Streaming, as used herein, is displaying the video of the audiovisual signal, playing the audio data of the audiovisual signal, or a combination thereof. The processor 108 may cause the audio device 110 to play the audio data. The method 200 includes an identify topic process 206 during which the processor 108 analyzes the audiovisual signal to identify topics. During an identify information process 208 of the method 200, the processor 108 identifies information stored within the knowledge pool 104 that is related to a topic identified during the identify topic process 206. The processor 108 inserts a visual asset into the video of the audiovisual signal during a visual asset process 210 of the method 200. The processor 108 causes the display device 114 to display the video of the audiovisual signal during a display process 212 of the method 200. Returning to the streaming process 204, the processor 108 continues to stream the audiovisual signal, identify topics, identify information related to the topics, and insert visual assets for the topics for a duration of the virtual meeting.

In some examples, as described above, the processor 108 may analyze the audiovisual signal utilizing a machine learning technique as described below with respect to FIGS. 5 and 6, a statistical technique, or a combination thereof during the identify topic process 206. For example, by analyzing a real-time transcript of the audio data of the audio data of the audiovisual signal, the processor 108 may determine that a topic is a recent news article. In another example, by analyzing the video of the audiovisual signal, the processor 108 may determine that a topic is a book based on an object an attendee of the virtual meeting displays to an image sensor of the attendee device 106. In yet another example, by analyzing the real-time transcript, the processor 108 may determine a user of the electronic device 102 is to record topics of the virtual meeting to create a presentation for later use.

In various examples, during the identify information process 208, the processor 108 identifies information stored within the knowledge pool 104 that is related to a topic identified during the identify topic process 206. The processor 108 receives information related to the topic from the knowledge pool 104. For example, responsive to the processor 108 determining that the topic is the recent news article, the processor 108 may transmit a subject of the recent news article to the knowledge pool 104. The processor 108 receives information that may include a link to a website hosting the recent new article, links to websites hosting other news articles related to the subject, a link to a website comprising information on the subject, a file on the subject, a video on the subject, or a combination thereof, for example. In another example, responsive to the processor 108 determining that the topic is the book the attendee displays to the image sensor of the attendee device 106, the processor 108 may transmit a title of the book to the knowledge pool 104. The processor 108 may receive information that includes a link to a website where the book may be purchased, a link to a website for an author of the book, links to websites hosting reviews of the book, a link to a website to a local library, a video interview of the author, or a combination thereof. In yet another example, responsive to the processor 108 determining the user is to record topics of the virtual meeting to create a presentation, the processor 108 may transmit an inquiry to the knowledge pool 104 requesting an application that the user may utilize to create the presentation. The processor 108 may receive a GUI of the application, a link to a website associated with the application, an identifier of the application, a list of applications that the user may utilize to create the presentation, a video demonstration how to create a presentation, or a combination thereof.

In some examples, the processor 108 inserts a visual asset into the video of the audiovisual signal during the visual asset process 210. For example, when the processor 108 receives the information from the knowledge pool 104, the processor 108 may insert the visual asset into a current frame of the video that corresponds to the receipt of the information. In another example, the processor 108 may determine a format of the visual asset based on the information received and insert the visual asset into a current frame that corresponds to the format determination. In various examples, the processor 108 inserts the visual asset into subsequent frames of the video such that the visual asset is continuously displayed. In other examples, the processor 108 duplicates frames of the video and inserts the visual asset into the duplicated frames to create a second video. The processor 108 causes the display device 114 to display the second video as the video of the audiovisual signal during the display process 212.

In various examples, the visual asset is continuously displayed for a specified duration. The specified duration may be measured in seconds, minutes, or frames. For example, the processor 108 may insert the visual asset into sixty frames of the video such that the visual asset is continuously displayed for sixty frames of the video. In another example, the processor 108 may insert the visual asset into frames of the video for sixty seconds. The processor 108 may determine the specified duration based on the topic, the information related to the topic, or a combination thereof. For example, the processor 108 may determine that the specified duration to display visual assets is thirty seconds. Responsive to a topic recurring periodically throughout the virtual meeting, the processor 108 may determine that the specified duration to display the visual asset associated with the topic is five minutes. In another example, the information identified may include the specified duration for which the processor 108 is to cause the display device 114 to display the visual asset associated with the information identified.

Returning to the streaming process 204, the processor 108 continues to stream the audiovisual signal, identify topics, identify information related to the topics, and insert visual assets for the topics for a duration of the virtual meeting. Utilizing the method 200 to identify topics of the virtual meeting and identify information related to the topics to present in the video of the audiovisual signal as visual assets, the electronic device 102 enhances the productivity of the user.

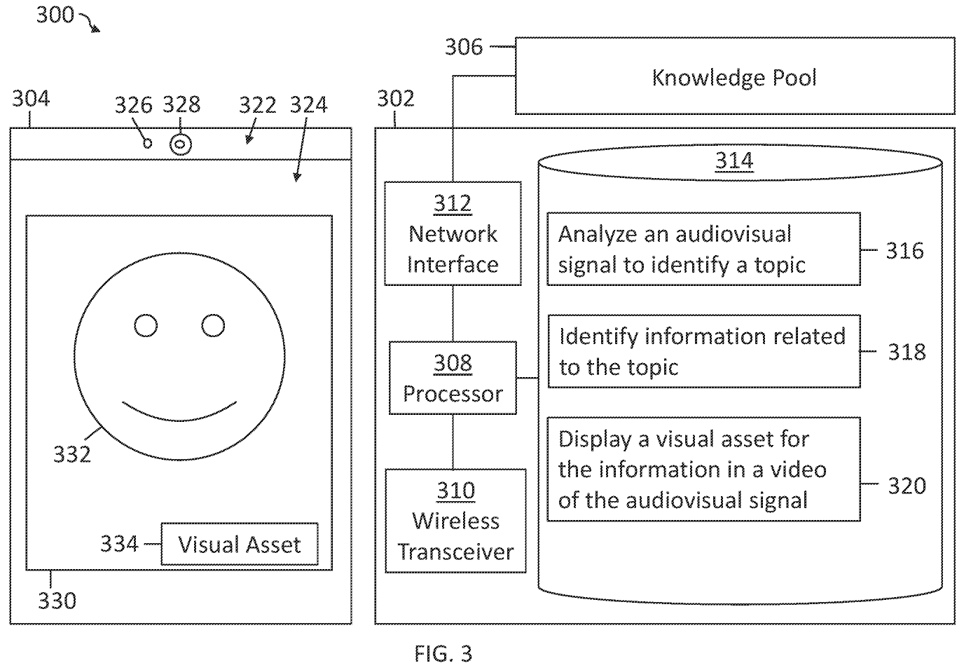

Referring now to FIG. 3, a block diagram depicting a system 300 for displaying visual assets of audiovisual signals is provided, in accordance with various examples. The system 300 may be the system 100. The system 300 may include an electronic device 302, a display device 304, and a knowledge pool 306. The electronic device 302 may be the electronic device 102. The display device 304 may be the display device 114. The knowledge pool 306 may be the knowledge pool 104. The electronic device 302 may include a processor 308, a wireless transceiver 310, a network interface 312, and a storage device 314. The processor 308 may be the processor 108. The wireless transceiver 310 is to transmit and receive wireless signals. The wireless signals may be WI-FI®, BLUETOOTH®, or a combination thereof. The network interface 312 may be the network interface 116. The storage device 314 may be the storage device 118. The display device 304 may include a chassis 322, a display panel 324, an audio device 326, and an image sensor 328. The chassis 322 may house the display panel 324, the audio device 326, and the image sensor 328. The display panel 324 may be an LCD panel, an LED display panel, a plasma display panel, a QD display panel, or any suitable panel for displaying data of the electronic device 102 for viewing. The audio device 326 may be the audio device 110. The image sensor 328 may be the image sensor 112. The display panel 324 may include a window 330 displaying an image 332 of an audiovisual signal and a visual asset 334 of the audiovisual signal.

In some examples, the electronic device 302 couples to the display device 304 and the knowledge pool 306. The electronic device 302 may couple to the display device 304 via the wireless transceiver 310 and the knowledge pool 306 via the network interface 312. In various examples, the processor 308 couples to the wireless transceiver 310, the network interface 312, and the storage device 314. In various examples, the processor 308 may couple to the display device 304, the audio device 326, the image sensor 328, or a combination thereof via the wireless transceiver 310 and the knowledge pool 306 via the network interface 312. The storage device 314 may store machine-readable instructions which, when executed by the processor 308, cause the processor 308 to perform some or all of the actions attributed herein to the processor 308. The machine-readable instructions may be the machine-readable instructions 316, 318, 320. The machine-readable instructions 316, 318, 320 may be the machine-readable instructions 120.

In various examples, when executed by the processor 308, the machine-readable instructions 316, 318, 320 cause the processor 308 to cause the display device 304 to display the visual asset 334 in a video representing an audiovisual signal. The machine-readable instruction 316 causes the processor 308 to analyze the audiovisual signal to identify a topic. The audiovisual signal may be received from an attendee device (e.g., the attendee device 106) via the network interface 312. Responsive to the processor 308 identifying the topic, the machine-readable instruction 318 causes the processor 308 to identify information related to the topic. The machine-readable instruction 320 causes the processor 308 to cause the display device 304 to display the visual asset 334 for the information in a video representing the audiovisual signal. In some examples, the video may be an image (e.g., the image 332). For example, responsive to an image sensor of the attendee device having an off state, the processor 308 may receive the image 332 as the video representing the audiovisual signal.

In some examples, referring to the method 200 described above with respect to FIG. 2, by executing a machine-readable instruction, the processor 308 starts a virtual meeting at the start point 202. By executing another machine-readable instruction, the processor 308 streams the audiovisual signal during the streaming process 204. The processor 308 may cause the display device 304 to display the video of the audiovisual signal in the window 330 and an audio output device (not explicitly shown) to play an audio data of the audiovisual signal. The audio output device may be an internal speaker, an external speaker, a headset, or any other suitable playback device. The video of the audiovisual signal may be the image 332. The processor 308 performs the identify topic process 206 to identify a topic in the audio data, in the video, or a combination thereof by executing the machine-readable instruction 316. By executing the machine-readable instruction 318, the processor 308 performs the identify information process 208 to identify the information related to the topic. The processor 308 inserts the visual asset 334 into the video representing the audiovisual signal by executing yet another machine-readable instruction. By executing the machine-readable instruction 320, the processor 308 may cause the display device 304 to display the visual asset 334 in the video representing the audiovisual signal.

In various examples, as described above with respect to FIG. 1, the processor 308 may analyze the video of the audiovisual signal and determine a topic based on an object displayed to the image sensor 328. The processor 308 may utilize a computer vision technique to analyze the video and determine the topic. The computer vision technique may include image classification, object detection, object tracking, semantic segmentation, instance segmentation, or a combination thereof. In some examples, the computer vision technique may include a convolutional neural network (CNN). For example, during the identify topic process 206, the processor 308 may utilize the computer vision technique to identify the object displayed to the image sensor 328.

In some examples, a user of the electronic device 302 may interact with the visual asset 334. For example, the user may select the visual asset 334. Responsive to the selection of the visual asset 334, the processor 308 may perform an action. In some examples, the visual asset 334 may be a GUI. Responsive to selection of the GUI, the processor 308 may execute an application to enable the user to perform a task. In other examples, the processor 308 may cause the display device 304 to display a second window, where the second window enables access to a website. In some examples, the website may provide access to an application that enables the user to perform the task. In various examples, the application or the second window may be embedded in the window 330. In other examples, the application or the second window may be a separate window outside of the window 330. In some examples, the processor 308 may prompt the user to modify a setting of the electronic device 302, to authorize the processor 308 to perform the action, or a combination thereof.

In some examples, the user may select the visual asset 334 via an input device (not explicitly shown), such as a mouse, a keyboard, a touchpad, or a combination thereof. In other examples, the user may select the visual asset 334 via the audio device 326. For example, after displaying the visual asset 334, the processor 308 may prompt the user to mute the audio device 326. Muting the audio device 326 prevents transmission of an audio data via the network interface 312. However, the processor 308 may still receive the audio data. The processor 308 may prompt the user to speak a command. Responsive to the processor 308 receiving the audio data comprising the command, the processor 308 may perform the action.

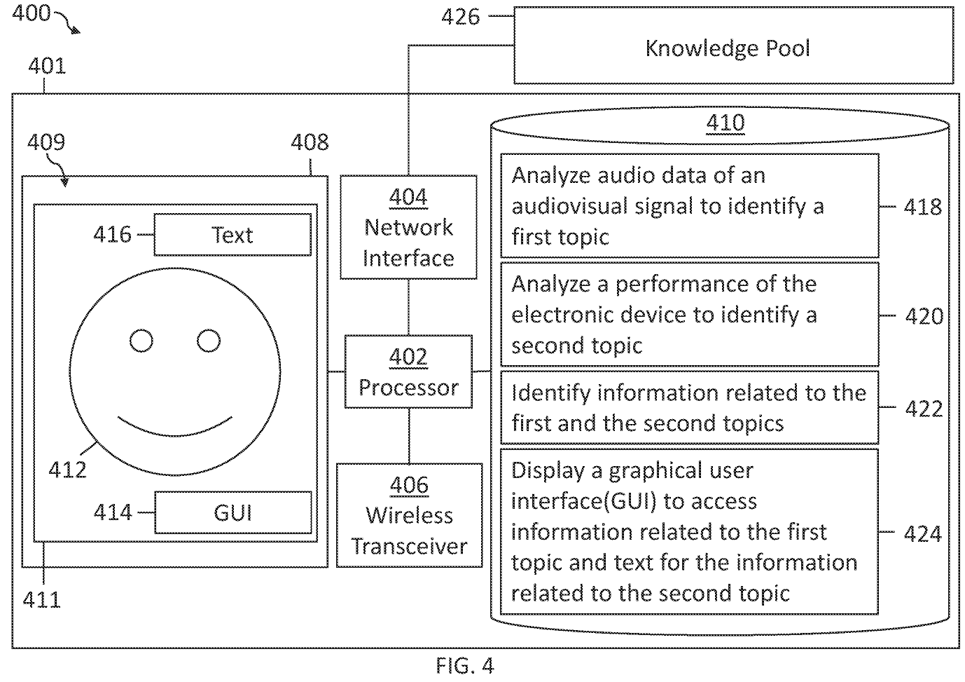

Referring now to FIG. 4, a block diagram depicting a system 400 for displaying visual assets of audiovisual signals is provided, in accordance with various examples. The system 400 may be the system 100, 300. The system 400 may include an electronic device 401 and a knowledge pool 426. The electronic device 401 may be the electronic device 102, 302. The knowledge pool 426 may be the knowledge pool 104, 306. The electronic device 302 may include a processor 402, a network interface 404, a wireless transceiver 406, a display device 408, and a storage device 410. The processor 402 may be the processor 108, 308. The network interface 404 may be the network interface 116, 312. The wireless transceiver 406 may be the wireless transceiver 310. The display device 408 may be the display device 114, 304. The storage device 410 may be the storage device 118, 314. The display device 408 may include a display panel 409. The display panel 409 may be the display panel 324. The display panel 409 may include a window 411 displaying an image 412 of an audiovisual signal and a first visual asset 414 and a second visual asset 416. The window 411 may be the window 330. The image 412 may be the image 332. The first visual asset 414, the second visual asset 416, or a combination thereof may be the visual asset 334.

In some examples, the electronic device 401 couples to the knowledge pool 426. The electronic device 401 may couple to the knowledge pool 426 via the network interface 404. In various examples, the processor 402 couples to the network interface 404, the wireless transceiver 406, the display device 408, and the storage device 410. In various examples, the processor 402 may couple to an audio device (e.g., the audio device 110, 326), an image sensor (e.g., the image sensor 112, 328), or a combination thereof via the wireless transceiver 406 and the knowledge pool 426 via the network interface 404. The storage device 410 may store machine-readable instructions which, when executed by the processor 402, cause the processor 402 to perform some or all of the actions attributed herein to the processor 402. The machine-readable instructions may be the machine-readable instructions 418, 420, 422, 424. The machine-readable instructions 418, 420, 422, 424 may be the machine-readable instructions 120.

In various examples, when executed by the processor 402, the machine-readable instructions 418, 420, 422, 424 cause the processor 402 to cause the display device 408 to display the first visual asset 414 and the second visual asset 416 in a video representing an audiovisual signal. The machine-readable instruction 418 causes the processor 402 to analyze audio data of the audiovisual signal to identify a first topic. The audiovisual signal may be received from an attendee device (e.g., the attendee device 106) via the network interface 404. The machine-readable instruction 420 causes the processor 402 to analyze a performance of the electronic device to identify a second topic. Responsive to the processor 402 identifying the first and the second topics, the machine-readable instruction 422 causes the processor 402 to identify information related to the first and the second topics. The machine-readable instruction 424 causes the processor 402 to cause the display device 408 to display the first visual asset 414 to access the information related to the first topic and the second visual asset 416 to access the information related to the second topic in a video representing the audiovisual signal.

As described above, a visual asset may be an image, a video, text, or a combination thereof. The first visual asset 414 and the second visual asset 416 may be images, videos, texts, or a combination thereof. For example, the first visual asset 414 may be a GUI and the second visual asset 416 may be text. In another example, the first visual asset 414 may be a first GUI and the second visual asset 416 may be a second GUI. In yet another example, the first visual asset 414 may be a video and the second visual asset 416 may be text. While the first visual asset 414 and the second visual asset 416 are shown in FIG. 4 as located at a top and a bottom right edge of the window 411, in other examples, the first visual asset 414 and the second visual asset 416 may be located side-by-side in the window 411. In various examples, the information related to the first and the second topic may include a location of the first and the second visual asset, respectively.

The second visual asset 416 may notify the user of a performance issue of the electronic device 401. In some examples, the second visual asset 416 may be text that notifies the user of a performance issue, prompts the user to perform a number of actions to resolve the performance issue, or a combination thereof. For example, the second visual asset 416 may be text that notifies the user of poor network connectivity, excessive memory usage, excessive CPU usage, excessive temperatures, low battery, or a combination thereof. In another example, the second visual asset 416 may be text that prompts the user to perform a number of actions to resolve the performance issue. The number of actions may include charging the electronic device 401, closing other applications executing on the electronic device 401, checking cable connections to the electronic device 401, changing a location of the electronic device 401, clearing a blocked vent of the electronic device 401, or a combination thereof. In other examples, the second visual asset 416 may be a link to an executable code to resolve the performance issue. The executable code may check for system updates that resolve the performance issue or check for malicious code on the system. Providing early notification to the user of performance issues of the electronic device 401 enhances the user experience by allowing the user to take corrective action.

In various examples, the information related to the first topic, the second topic, or a combination thereof is associated with a domain. For example, the information related to the first topic may be a link to a website of the domain, and the information related to the second topic may be text that prompts the user to perform a number of domain-specific actions to resolve the performance issue.

Referring now to FIG. 5, a block diagram depicting an electronic device 500 for displaying visual assets of audiovisual signals is provided, in accordance with various examples. The electronic device 500 may be the electronic device 102, 302, 401. The electronic device 500 comprises a processor 502, a network interface 504, a display device 506, and a non-transitory machine-readable medium 508. The network interface 504 may be the network interface 116, 312, 404. The display device 506 may be the display device 114, 304, 408. The non-transitory machine-readable medium 508 may be the storage device 118, 314, 410. As described above, the term “non-transitory” does not encompass transitory propagating signals.

In various examples, the electronic device 500 comprises the processor 502 coupled to the network interface 504, the display device 506, and the non-transitory machine-readable medium 508. The non-transitory machine-readable medium 508 may store machine-readable instructions. The machine-readable instructions may be the machine-readable instructions 510, 512, 514, 516, 518, 520. The machine-readable instructions 510, 512, 514, 516, 518, 520 may be the machine-readable instructions 120. The machine-readable instructions 510, 512, 514, 516, 518, 520, when executed by the processor 502, cause the processor 502 to perform some or all of the actions attributed herein to the processor 502.

In various examples, when executed by the processor 502, the machine-readable instructions 510, 512, 514, 516, 518, 520 cause the processor 502 to cause the display device 506 to display visual assets (e.g., the visual asset 334, the first visual asset 414, the second visual asset 416) of audiovisual signals. The machine-readable instruction 510 may cause the processor 502 to create a real-time transcript of audio data of a first and a second audiovisual signal. The processor 502 may receive the first audiovisual signal from an attendee device (e.g., the attendee device 106) via the network interface 504. The processor 502 may receive the audio data of the second audiovisual signal via an audio input device (e.g., the audio device 110, 326, an audio device coupled to the wireless transceiver 406). The machine-readable instruction 512 may cause the processor 502 to identify a topic of the real-time transcript utilizing a machine learning technique. The machine-readable instruction 514 may cause the processor 502 to identify information related to the topic. The processor 502 may identify the information utilizing a knowledge pool (e.g., the knowledge pool 104, 306, 426) via the network interface 504. The machine-readable instruction 516 may cause the processor 502 to insert a visual asset for the information in a first video representing the first audiovisual signal and in a second video representing a second audiovisual signal. The processor 502 may receive the second video via an image sensor (e.g., the image sensor 112, 328, an image sensor coupled to the wireless transceiver 406). The machine-readable instruction 518 may cause the processor 502 to cause the display device 506 to display the first video comprising the visual asset. The machine-readable instruction 520 may cause the processor 502 to transmit the second audiovisual signal comprising the visual asset. The processor 502 may transmit the second audiovisual signal via the network interface 504.

Referring now to FIG. 6, a flow diagram depicting a method 600 for the electronic device 500 to display visual assets of audiovisual signals is provided, in accordance with various examples. At a start point 602 of the method 600, the processor 502 executes an executable code that enables a virtual meeting. The processor 502 causes the display device 506 to display a video of the first audiovisual signal, causes an audio output device (e.g., an audio output device coupled to the wireless transceiver 406) to play an audio data of the first audiovisual signal, receives a video of the second audiovisual signal via the image sensor, receives an audio data of the second audiovisual signal via the audio input device, or a combination thereof during a streaming process 604 of the method 600. During the monitor process 606, the processor 502 monitors a performance of the electronic device 500. While the method 600 depicts the streaming process 604 and the monitor process 606 as starting simultaneously, in some examples, the processor 502 may start the streaming process 604 and the monitor process 606 sequentially, in any order.

The processor 502 creates the real-time transcript of the audio data of the first and the second audiovisual signals during a real-time transcript process 608 of the method 600. The real-time transcript is a dialogue between a user of the electronic device 500, as received in the audio file of the second audiovisual signal, and a user of the attendee device, as received in the audio file of the first audiovisual signal. During an identify topic process 610 of the method 600, the processor 502 analyzes the real-time transcript to identify topics. The processor 502 may utilize a machine-learning technique as described below, a statistical technique as described above, or a combination thereof to analyze the real-time transcript and identify topics. During an intercept process 612, the processor 502 intercepts the videos of the first and the second audiovisual signals. During an identify information process 614 of the method 600, the processor 502 identifies information stored within the knowledge pool that is related to the topic identified during the identify topic process 610. The processor 502 inserts a visual asset into the video of the first audiovisual and the video of the second audiovisual signal during a visual asset process 616 of the method 600. The processor 502 transmits the second audiovisual signal via the network interface 504 during a transmit process 618 of the method 600. The processor 502 causes the display device 506 to display the video of the first audiovisual signal during a display process 620 of the method 600. During the monitor process 622 of the method 600, the processor 502 monitors for a selection of the visual asset. Responsive to the selection of the visual asset, the processor 502 performs an action associated with the visual asset in a perform action process 624 of the method 600. The processor 502 continues the processes of the method 600 for a duration of the virtual meeting.

In some examples, the processor 502 intercepts the videos of the first and the second audiovisual signals during the intercept process 612. The processor 502 intercepts the videos in response to the creation of the real-time transcript during the real-time transcript process 608, the identification of a topic in the identify topic process 610, or a combination thereof. As described above with respect to FIG. 2, the processor 502 may intercept the videos to insert the visual asset into the videos or to create duplicate frames of the videos to insert the visual asset into the duplicated frames. In some examples, the processor 502 inserts the real-time transcript as a first visual asset of the videos during the visual asset process 616 and inserts the visual asset for the information identified in the identify information process 614 as a second visual asset of the videos. As described above with respect to FIG. 2, the processor 502 may insert the visual asset into a current frame of the videos that corresponds to the receipt of the information, the format determination for the visual asset, or a combination thereof. For example, the processor 502 may insert the real-time transcript as a first visual asset into a first frame of the videos and insert updates to the real-time transcript as subsequent visual assets during subsequent frames. In another example, the processor 502 may insert the topic as a first visual asset into a first frame of the videos and insert the information related to the topic as a second visual asset into a subsequent frame of the videos. In some examples, the processor 502 may insert multiple visual assets into a frame of the videos.

In various examples, the processor 502 may utilize a machine learning technique during the real-time transcript process 608, the identify topic process 610, or a combination thereof. The machine learning technique may utilize a speech recognition technique, a speech model, or a combination thereof to identify a topic. The speech recognition technique may utilize a Hidden Markov Model (HMM) to recognize patterns in the audio data, for example. The speech model may account for grammar, vocabulary, or a combination thereof, for example. In some examples, the processor 502 enables the customization of the speech model to include specialized vocabulary. The specialized vocabulary may be related to a shared interest, an organization, a business entity, an industry, or a combination thereof. In various examples, a first output of the machine learning technique may be the real-time transcript generated during the real-time transcript process 608. The processor 502 may identify a topic or a list of topics by determining statistical properties of the real-time transcript to extract words, phrases, or a combination thereof, that have a high frequency of occurrence or a high degree of emphasis. In some examples, a second output of the machine learning technique may be the topic or the list of topics.

By performing the method 600 to display visual assets of audiovisual signals, the electronic device 500 enhances the productivity of the user. Providing early notification to the user of performance issues of the electronic device 500 enhances the user experience by allowing the user to take corrective action. Transmitting the early notification of performance issues of the user to other attendees of the virtual meeting, enhances the attendee experience by alerting the attendees to a potential impact on the virtual meeting, and enhances the productivity of the attendees by allowing them to proactively adapt to the impact. Providing the information related to the topics to both the user and the attendees enhances productivity of the virtual meeting by facilitating the sharing and access to relevant information.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein may be shown in exaggerated scale or in somewhat schematic form, and some details of certain elements may not be shown in the interest of clarity and conciseness. In some of the figures, in order to improve clarity and conciseness, a component or an aspect of a component may be omitted.

In the above description and in the claims, the term “comprising” is used in an open-ended fashion, and thus should be interpreted to mean “including, but not limited to....” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a network interface; and
a processor to:
analyze an audiovisual signal received via the network interface to identify a topic;
identify information related to the topic; and
cause a display device to display a visual asset for the information in a video representing the audiovisual signal.

2. The electronic device of claim 1, wherein the processor is to analyze the audiovisual signal utilizing a statistical technique, a machine-learning technique, or a combination thereof to identify the topic.

3. The electronic device of claim 1, wherein the visual asset is an image, a second video, text, or a combination thereof.

4. The electronic device of claim 3, wherein the visual asset is a graphical user interface (GUI) for an application, a link to a file comprising data associated with the application, or a combination thereof.

5. The electronic device of claim 3, wherein the visual asset is a link to a website, a link to a file comprising data associated with the website, or a combination thereof.

6. An electronic device, comprising:
a network interface; and
a processor to:
analyze audio data of an audiovisual signal received via the network interface to identify a first topic;
analyze a performance of the electronic device to identify a second topic;
identify information related to the first and the second topics; and
cause a display device to display a video representing the audiovisual signal, the video including a graphical user interface (GUI) to access the information related to the first topic and text for the information related to the second topic.

7. The electronic device of claim 6, wherein the information related to the first topic, the second topic, or a combination thereof is associated with a domain.

8. The electronic device of claim 6, wherein responsive to a selection of the text, the processor is to prompt a user to mute an audio device and speak a command, modify a setting, authorize an action, or a combination thereof.

9. The electronic device of claim 6, wherein the text is to notify a user of a performance issue, prompt the user to perform a number of actions to resolve the performance issue, or a combination thereof.

10. The electronic device of claim 9, wherein the text is a link to an executable code to resolve the performance issue.

11. A non-transitory machine-readable medium storing machine-readable instructions which, when executed by a processor of an electronic device, cause the processor to:
create a real-time transcript of audio data of a first audiovisual signal received via a network interface and audio data of a second audiovisual signal received via an audio input device;
identify a topic of the real-time transcript utilizing a machine learning technique;
identify information related to the topic via the network interface;
insert a visual asset for the information in a first video representing the first audiovisual signal and in a second video representing the second audiovisual signal;
cause a display device to display the first video comprising the visual asset; and
cause the network interface to transmit the second audiovisual signal comprising the visual asset.

12. The non-transitory machine-readable medium of claim 11, wherein the visual asset is an image, a third video, text, or a combination thereof.

13. The non-transitory machine-readable medium of claim 11, wherein, the processor is to insert the real-time transcript as a second visual asset into the first video and the second video.

14. The non-transitory machine-readable medium of claim 11, wherein, responsive to a selection of the visual asset, the processor is to execute an application to enable a user to perform a task, cause the display device to display a second window, where the second window is to enable access to a website, or a combination thereof.

15. The non-transitory machine-readable medium of claim 11, wherein, responsive to a selection of the visual asset, the processor is to prompt a user to mute an audio device and speak a command, to modify a setting, to authorize the processor to perform an action, or a combination thereof.
